(19) United States
(12) Patent Application Publication
(10) Pub. No.: US 2005/0251747 A1
(43) Pub. Date: Nov. 10, 2005

(54) Tool and method for configuring, designing or programming an installation

(75) Inventors: Peter Dolling, Furth (DE); Efthimios Liakos, Nurnberg (DE); Jochen Steiner, Rosstal (DE); Doris Urbanger, Feucht (DE)

Correspondence Address: Siemens Corporation;Intellectual Property Department, 170 Wood Avenue South, Iselin, NJ, 08830, US

(73) Assignee: Siemens Aktiegesellschaft, Muenchen (DE)

(21) Appl. No.: 10/523,513

(22) PCT Filed: Jul. 23, 2003
(86) PCT No.: PCT/DE03/02486

§ 371 Date: Feb. 4, 2005

(30) Foreign Application Priority Data
Aug. 5, 2002 (DE) 102 35 517.7

(51) Int. Cl. G06F 3/00

(52) U.S. Cl. 715/713; 715/850; 715/851; 715/712; 715/818

(57) ABSTRACT

The invention relates to a tool comprising a computer, a memory, input elements and a display. The control program that is stored in the memory and contains user prompting information and menus is converted into displays, each having two disparately organized navigation areas and a data area. The first navigation area facilitates an overview of the entire task. The second navigation area displays individual work steps in the sequence in which they are to be processed. A tool provided by the invention is preferably used for the purposes of configuring, designing or programming an installation, for example an installation in the field of drive engineering.

### CROSS REFERENCE TO RELATED APPLICATIONS

This application is the U.S. National Stage of International Application No. PCT/DE2003/002486, filed Jul. 23, 2003 and claims the benefit thereof. The International Application claims the benefits of German application No. 10235517.7 filed Aug. 5, 2002, both applications are incorporated by reference herein in their entirety.

### FIELD OF THE INVENTION

The invention relates to a tool. This can be used for example when configuring installations in the field of drive engineering. The invention also relates to a method for configuring an installation and a digital storage medium. A tool according to the invention can also be used in conjunction with the design or programming of an installation.

### BACKGROUND OF THE INVENTION

A plurality of sub-tasks has to be processed in the context of a configuration process, with work steps being assigned to each sub-task. To assist the user, it is already known that so-called assistants or wizards can be provided, which facilitate task processing for the user. These assistants are displayed in the form of a screen window on the display of the respective configuration tool and generally contain text information, which informs the user which data has to be input in the context of a work step and which form said data input has to take. Such an assistant can comprise a plurality of text pages, which have to be called up by the user in sequence.

A programming tool for configuring and managing a process control network including the use of spatial information is already known from DE 101 02 205 A1. This programming tool is implemented using a programming workstation, which is linked to a local data network. An operator workstation, a laboratory workstation and controllers/multiplexers are also connected to the local data network. The controllers/multiplexers act as electrical interfaces between the workstations and a plurality of processes. The programming workstation has a processor, a display, a storage unit and user interface devices such as a keyboard, a light pen, etc. A control program is stored in the storage unit and executed using the processor in order to implement operations and functions of the process control environment. The programming tool is used to configure the process control network and to ensure that the process control network corresponds to a required standard protocol, for example the field bus protocol. Screen presentations are thereby displayed on the display of the programming workstation, which either just display the logical links of a process or contain physical connections, which contain the spatial characteristics of the layout of an installation. The screen is divided into different areas, including for example a color bar menu area, a pictogram menu area, a template menu area and a diagram area. When designing a process control environment using logical links, a user activates a template from the template menu area and drags the active template to the required position inside the diagram area.

A method and a graphic tool for configuring electrical installation components of a building are known from EP 1 134 864 A1. A device list is thereby provided in a screen window, which contains the devices to be configured. A space to be configured is represented by a specific, further screen window. Devices are assigned to the space to be configured from the said device list. The devices assigned to the space are displayed in the window assigned to the space. The devices placed in the space screen window are then connected graphically to each other by means of electric circuits using assistants or wizards.

A graphic user interface is known from U.S. Pat. No. 6,005,566, with which the user is able to control the type of information associated with an object. Different aspects of a selected object, for example a vehicle, are displayed in different fields of a display. The user is able to navigate within fields to select an item displayed there.

US 2002/0003548 A1 discloses a method for controlling network devices via a user interface. Icons for all the devices and/or services connected to the network are thereby displayed hierarchically. Each of the said icons is also linked to functions of a respectively assigned device or service.

A method and a device for presenting project planning and computer-assisted design are known from WO 01/03049 A1. An operator interface for example is displayed, having a project planning section, forward and back buttons and a design section. The individual tasks of a project are displayed in a tree structure in the project planning section.

### SUMMARY OF THE INVENTION

The object of the invention is to improve the user-friendliness of a tool for configuring, designing or programming an installation.

This object is achieved by the claims. Advantageous embodiments and developments will emerge from the dependent claims.

The advantages of the invention relate in particular to the fact that two different, disparately organized navigation areas are available to the user at the same time. The first navigation area is particularly suited to providing a general overview of the current project or task. This is particularly advantageous, when the user resumes work after a break of any length. It also has advantages for a subsequent processor wishing to continue the work and for other people wishing to obtain an overview of the current status of the entire task. The second navigation area is particularly suited to the execution of the task itself, as the work steps to be carried out are displayed in their processing sequence in the second navigation area. This makes it significantly easier for the user to be able to execute the work steps they need to carry out in the predefined sequence.

If the first navigation area has a tree structure, this gives the person observing the display a particularly good overview of the project in hand.

If the second navigation area also contains pictorial or graphic elements, for example a representation of a motor and a power circuit, this assists in particular experienced operators in processing their tasks.

The option of being able to select a required work step both in the first and in the second navigation areas takes into account the working practices of different user groups.

Marking the representations associated with the current work step in both navigation areas facilitates the user's overview of the work process as does provision of status indicators.

### BRIEF DESCRIPTION OF THE DRAWINGS

Further advantageous characteristics of the invention will emerge from the description which follows of an exemplary embodiment with reference to the Figures, in which:

FIG. 1 shows a block diagram of a configuration tool according to the invention and

FIGS. 2-8 show examples of the graphic user interfaces shown on the display.

### DETAILED DESCRIPTION OF THE INVENTION

The invention relates to a tool, as can be used with all activities to be processed using a computer, which are to be processed in the form of a plurality of sub-tasks and work steps. The tool according to the invention is preferably a configuration, design or programming tool. The invention is described below by way of an example with reference to a configuration tool.

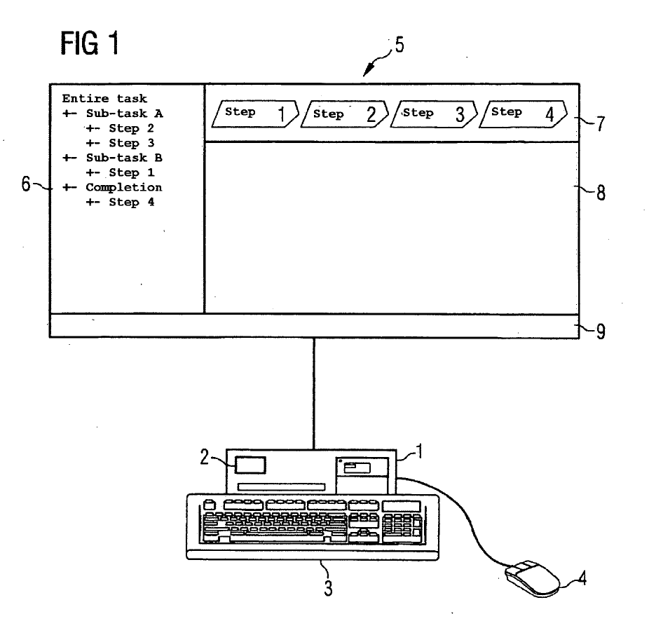

The configuration tool shown in FIG. 1 has a computer 1, a storage unit 2 inserted into the computer, a keyboard 3, a mouse 4 and a display 5. The storage unit 2 is preferably a CD-ROM. Control signals and data that can be read using the computer and converted by it are stored on said storage unit and interact with the further components of the configuration tool shown in the FIG such that a user is assisted with the processing of a configuration process. The stored data is displayed as a function of the progress of the configuration method on the display 5, to give users an overview of the project in hand, give them information relating to the sequence of the sub-tasks and work steps to be processed, provide them with status information about the status of the configuration process and offer them objects for selection as a function of the current work step and also provide general information relating to the current work step as a function of the current work step.

The display 5 is divided into a plurality of display areas. The display area 6 is a first navigation area. The sub-tasks and work steps associated with a project can be displayed in a hierarchically organized manner in this first navigation area. This takes place preferably using a tree structure, which gives the user a good overview of the entire project or—in the case of major projects—a good overview of a large part of the project. To save space the data displayed in the area 6 with the tree structure is preferably displayed in alphanumeric form, in particular in the form of keywords. This good overview of the entire project is particularly advantageous when the user resumes work after a break in the configuration process. Said user quickly obtains information again about the current status of the configuration process from the display in the first navigation area 6. The good overview of the entire project is also advantageous, when two or more people share the configuration work. Each of these people is immediately informed about the current status of the configuration work when they resume configuration work.

Navigation in this first navigation area 6 also allows selection of a required work step. To this end the user positions a cursor or another pointer element on the alphanumeric representation corresponding to the required step using the cursor control keys on the keyboard 3 or using the mouse 4 and then selects this step by clicking on it. The result of this selection is that the data displayed in the second navigation area 7, the data displayed in the data area 8 and the data displayed in the information field 9 change correspondingly. In particular a plurality of successive work steps are displayed in their processing sequence in the second navigation area 7, one of these displayed steps being the step selected in the first navigation area 6.

If—as described above—a required work step is selected in the first navigation area 6, to identify the selection made the wording corresponding to the selected step or the wording of the sub-task corresponding to the selected step in the first navigation area 6 and the wording associated with the selected step and/or the associated pictorial representation in the second navigation area 7 are visually marked.

The display area 7 is—as mentioned above—a second navigation area. In this second navigation area individual work steps associated with the project can be displayed in their processing sequence. For example in FIG. 1 a total of four work steps are represented in the second navigation area 7 by graphic and alphanumeric elements, which have to be processed in the sequence shown in the context of the configuration process. If the processing of a plurality of steps has been completed, it is possible to return to each of the steps already processed using the cursor control keys on the keyboard 3 or using the mouse 4. This is done for example to check previously input or selected data once again. Such navigation in the display area 7 also results in the displays in the first navigation area 6, in the data area 8 and in the information area 9 changing as a function of the currently selected work step.

In the first navigation area 6 the wording corresponding to the selected step or the wording corresponding to the current sub-task is visually marked to identify the selection made in the second navigation area 7. Data associated with the selected step is then displayed in the data area 8. This display is preferably in the form of a table or list with a button assigned to each of the elements in said list. If one of these buttons is marked using the mouse or cursor control keys, an assistant or wizard opens in the form of a window, which is displayed over the data area 8 and either contains further information about the selected list element or requests the inputting of data relating to the selected list element.

In the information field 9 general information relating to the configuration process, in particular the currently selected work step or currently selected sub-task is given in alphanumeric form, preferably in the form of complete sentences.

When a selected work step has been processed, the representations associated with this step are assigned a completion marker in both navigation areas 6 and 7, as set out in the description which follows of the further figures.

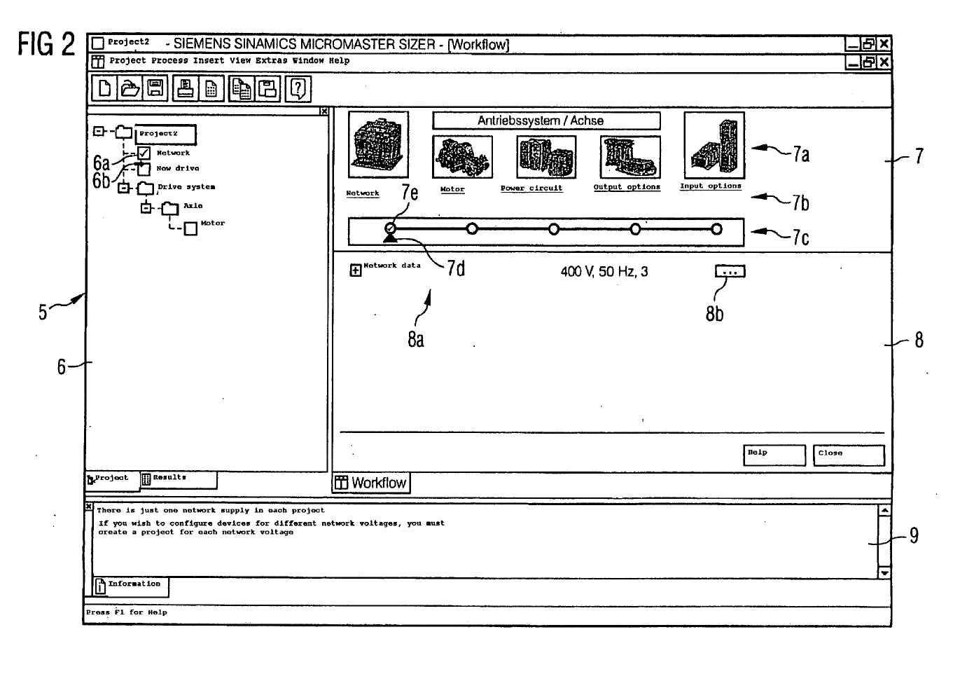

FIGS. 2 to 8 show examples of graphic operator interfaces, as displayed in the various stages of a configuration process relating to electrical drive engineering on the display 5. With all these representations a first navigation area 6, a second navigation area 7 and a data area 8 are provided on the display. An information area or information field 9 is also provided on the display, in which general information relating to the configuration process is displayed. This general information relates in particular to the currently selected work step or the currently selected sub-task and is displayed in the form of complete sentences.

The data displayed in the first navigation area 6 gradually forms a tree structure during the course of the configuration process, giving the user an overview of the entire project, which can comprise a plurality of sub-projects.

The elements displayed in the second navigation area 7 include both alphanumeric components 7b and graphic components 7a. These display elements are associated with individual work steps and are displayed in their processing sequence. It can therefore be derived from the second navigation area 7 shown in FIG. 2 that the work steps network, motor, power circuit, output options and input options have to be processed in the context of the configuration of a new drive. A status display 7c is provided below these display elements 7a and 7b. This has a horizontal bar containing a plurality of circular marker elements, each marker element being assigned to one work step.

The currently selected work step is marked by a triangular wedge 7d, the tip of which points to the circular marker element assigned to the selected work step. In the representation according to FIG. 2 the currently selected work step is the network. For example, the green check 7e in the circular marker element of the work step network shows that this step has already been completed.

Network data associated with the currently selected work step, i.e. the work step network, is displayed in the data area 8. In the exemplary embodiment shown this is the data “400 V, 50 Hz, 3”. A button 8b is also assigned to the displayed network data. Clicking on this superimposes a window on the current display to display further information relating to the network data.

The data displayed in the first navigation area 6 also has a status display. A green check 6a is thus marked in a box associated with the currently selected work step network to signal to the user that this work step has already been completed. The arrow 6b in the box assigned to the wording “New drive” means that the currently selected work step is associated with the configuration of a new drive.

The following two sentences are displayed in the information field 9:

“There is just one network supply in each project. If you wish to configure devices for different network voltages, you must create a project for each network voltage.”

These two sentences provide the user with general information about the currently selected work step.

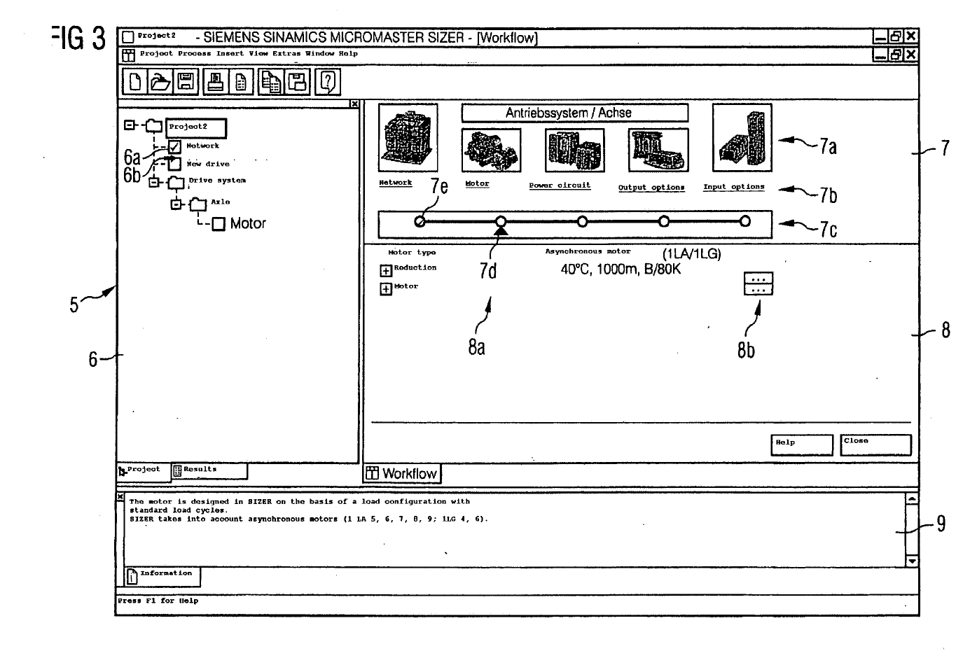

FIG. 3 shows a display, as generated by the computer 1 running the control program after clicking on the word “Motor” in the first navigation area 6 or the second navigation area 7 or by clicking on the graphic representation of the motor in the second navigation area 7. The display according to FIG. 3 is different from the display according to FIG. 2 in that the triangular wedge 7d now points to the circular marker element associated with the work step “Motor” and that data associated with the work step “Motor” is displayed in the data area 8 in the form of a list or table 8a, with one button 8b assigned to each of these items of data. General information relating to the selection of the motor is also displayed in the information area 9.

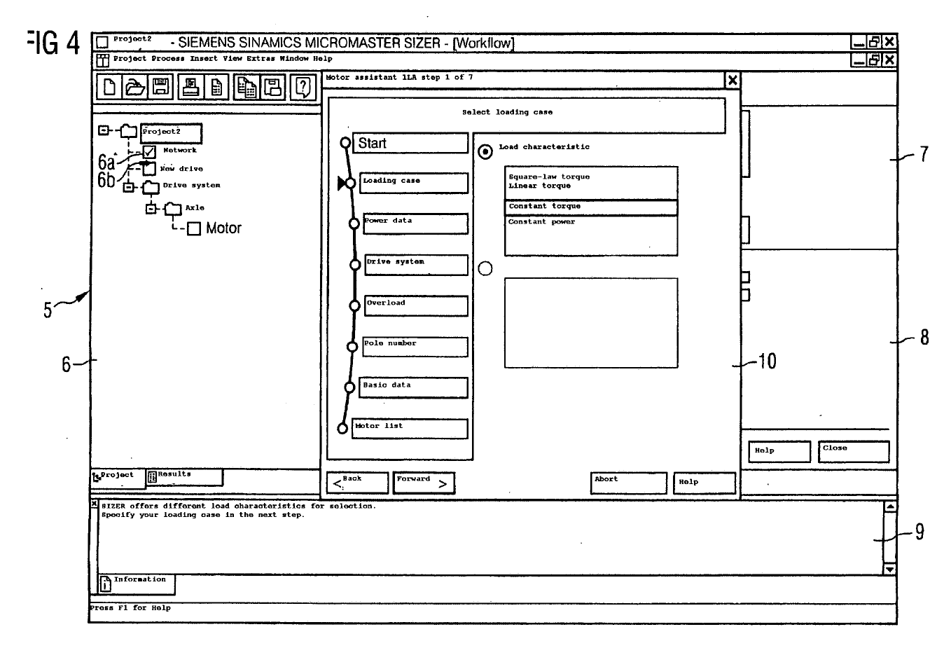

FIG. 4 shows a display corresponding to FIG. 3, on which however—after clicking on the button 8b in FIG. 3—a window corresponding to a motor assistant is superimposed on the display. This prompts the user to input further data relating to selection of the motor. The user has for example to select the load characteristic and specify the pole number. The user is provided with further information relating to the motor selection in the information field 9.

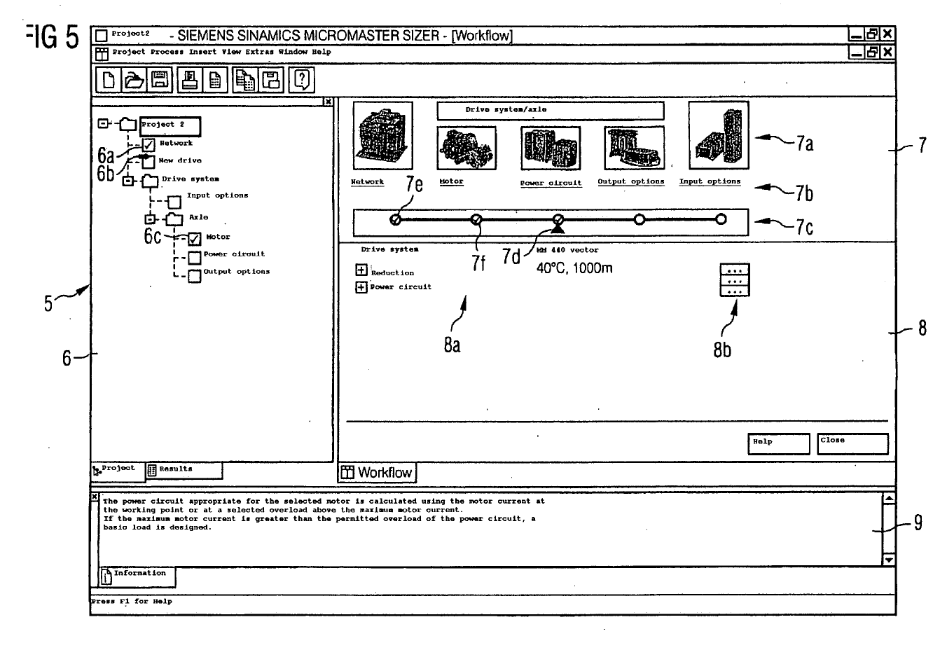

FIG. 5 shows a display as generated by the computer 1 running the control program after clicking on the words “Power circuit” in the first navigation area 6 or in the second navigation area 7 or by clicking on the graphic representation of the power circuit in the second navigation area 7. The display according to FIG. 5 is different from the display according to FIG. 3 in that the triangular wedge 7d now points to the circular marker element associated-with the work step “Power circuit” and that data associated with the work step “Power circuit” is displayed in the data area 8 in the form of a list or table 8a, with one button 8b assigned to each of these items of data. General information is also displayed in the information field 9 relating to selection of the power circuit. Also to identify that the work step “Motor” has already been processed, a green check 6c is shown in the box associated with the wording “Motor” in the first navigation area 6 and a green check 7f is shown in the circular marker element associated with the wording “Motor” in the second navigation area 7. It can also be seen from the display of the first navigation area 6 that the tree structure gradually builds up during the course of the configuration process.

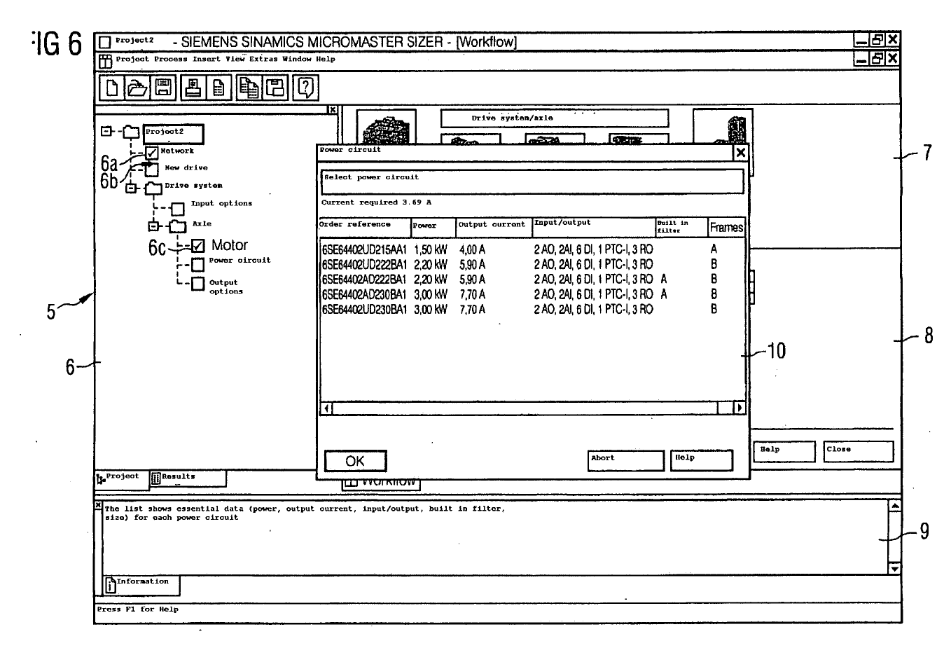

If the user clicks on the button 8b associated with the power circuit in the display according to FIG. 5, the computer 1 running the control program stored in the storage unit 2 generates a display according to FIG. 6. This has a window 10 superimposed on the further display, in which the user is prompted to select the power circuit. The user is also offered a selection of different power circuits in this window. The user is given further information relating to selection of the power circuit in the information field 9.

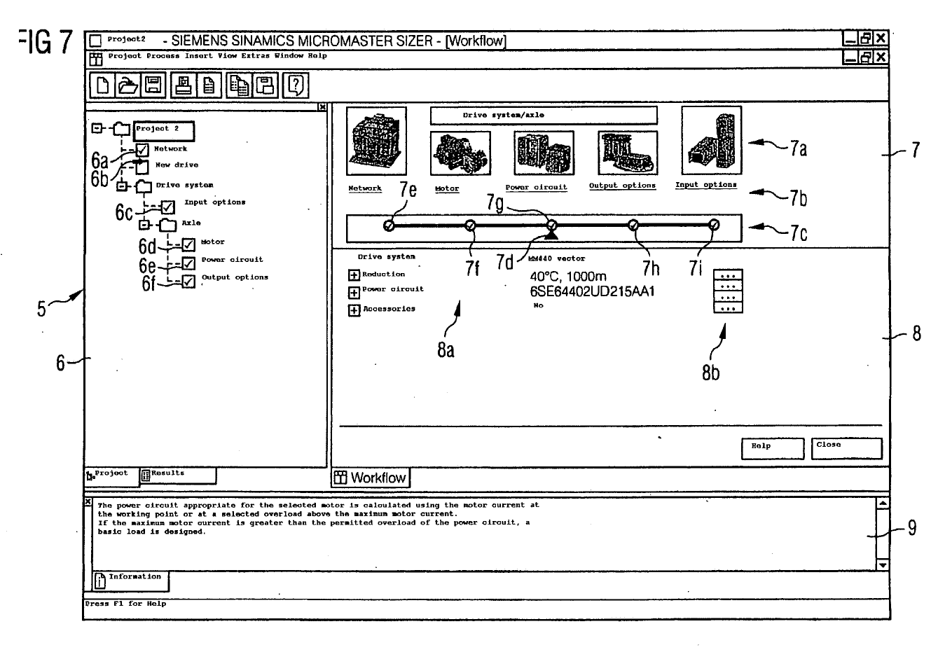

FIG. 7 shows a display as displayed after completion of the configuration of a new drive system, when the user clicks on the power circuit. Clicking on the power circuit is demonstrated by the positioning of the triangular wedge 7d at the circular marker element associated with the work step “Power circuit”. The green checks 7e, 7f, 7g, 7h and 7i show that all the work steps relating to this drive system have already been completed. Processing of all the work steps relating to the selected drive system is also indicated by the similarly green checks 6a, 6b, 6c, 6d, 6eand 6f in the first navigation area 6.

In one embodiment of the invention, if for example in the context of configuration in one work step a power circuit is selected, which is not compatible with components already selected in previous work steps, for example the supply network or a specific motor, all non-compatible components are identified by red checks so that the user can select other mutually compatible components.

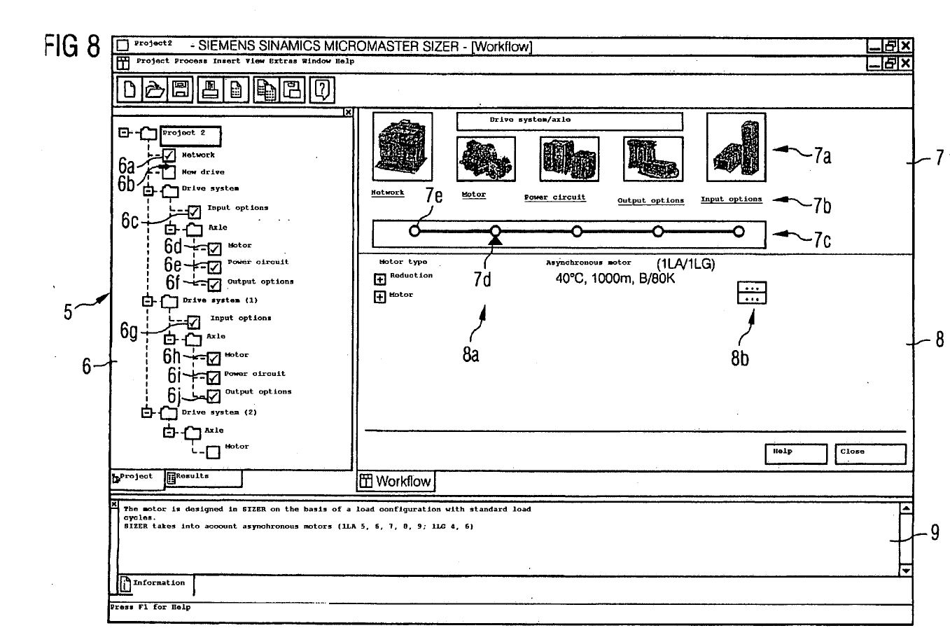

FIG. 8 shows a display, in which it can be seen from the first navigation area 6 that a plurality of sub-projects are associated with the overall project to be configured. These are designated “Drive system”, “Drive system 1” and “Drive system 2”. The sub-projects “Drive system” and “Drive system 1” have already been fully configured, as shown by the checks 6a, . . . , 6j in the first navigation area 6. The triangular wedge 7d in the second navigation area 7, positioned at the circular marker element associated with the motor, indicates that the currently selected work step is the work step “Motor”. The motor associated with the drive system 2 is selected in this work step. Selection of a suitable motor is facilitated for the user by the table 8a displayed in the data area 8. The user can obtain further information about motors available for selection by clicking on the button 8b and from the information in the information area 9.

The computer 1 thus runs the control program stored in the storage unit 2, with which menus and dialog texts are also associated, in the form of representations that can be displayed on the display 5. These each have two navigation areas 6, 7 and a data area 8. The two navigation areas are organized disparately. The first navigation area 6 provides a good overview of the entire project or at least a large part of it. Selection of a required work step by navigating in the first navigation area 6 allows the information content of the second navigation area 7 and the data area 8 to the adapted to the selection made. Individual work steps are shown in their processing sequence in the second navigation area 7. This is particularly advantageous in the configuration phase itself. The user preferably also obtains information relating to the currently selected work step in an information area 9 of the display 5, which is provided in addition to the navigation areas 6 and 7 and the data area 8. As an alternative to selecting a required work step by navigating and clicking in the first navigation area 6, the required work step can also be selected by navigating and clicking in the second navigation area 7. The information content in the first navigation area 6 and the data area 8 is also adapted after such a selection.

The second navigation area 7 is divided into individual command elements. A command element thereby maps a work step to be carried out by the user. All these command elements in the sequence to be observed by the user in the configuration process form the second navigation area, which is also referred to as the workflow navigation area. Any of these command elements can be selected and then displays to the user the data associated with the respective work step in the data area or gives the user the option of inputting or changing data. This workflow navigation area 7 is processed from left to right and defines a sequence during the first processing operation. Once all the work steps, which are selected by the user in sequence using the said command elements, have been processed, the entire task is closed or the configuration process is terminated.

Additional assistance can be obtained for the user by providing buttons “FORWARD” and “BACK” buttons. These are used in particular to prompt those learning the system or first-time users in an optimum manner.

If changes have to be made to already configured projects, the required work step can be selected using these “FORWARD” and “BACK” buttons or by direct selection in the second navigation area 7.

The second navigation area 7 or workflow navigation area described above is supplemented by the first navigation area 6 with its tree structure. This shows the user the hierarchical structure of the work steps or elements to be processed, thereby facilitating a structured search. The tree structure of the first navigation area 6 provides a good overview of the entire configuration task. This is particularly helpful for new entire tasks and after fairly long breaks or even when another user wishes to continue an already started entire task.

The currently selected work step is marked in both navigation areas. If the user starts to navigate in the second navigation area 7, the marking is also displaced correspondingly in the first navigation area. The user thereby gets to know the hierarchical structure and can find their way about there easily. It is possible to move between the two navigation areas 6 and 7 at any time.

The status indicators in both navigation areas show the user whether or not work steps have already been completed. It can also be indicated whether work steps need to be verified again or have become invalid. In the hierarchical view collative status information for entire hierarchical trees can provide the user with additional status information. This status information allows a quick overview of the progress of the entire task even during a change of processor.

It is possible to stop configuration work at any time and continue it at any later time. The user is also assisted in task processing when the sequence of work steps is predefined. The user is not however bound by this sequence if changes should be made at a later stage.

In one advantageous development of the invention, when a menu is offered the user is only able to click on or select those list elements, which are compatible with elements or devices that have already been selected.

1.-14. (canceled)

15. A tool for configuring, designing, or programming, the tool comprising:
a storage unit for storing a control program;
an operating unit for inputting operator commands;
a computer; and
a display for displaying a graphic user interface having a first navigation area, a second navigation area, and a data area, wherein
the first navigation area is an area, in which the sub-tasks and work steps associated with a project can be displayed in a hierarchically organized manner, wherein
the second navigation area is an area, in which individual work steps associated with the project can be displayed in their processing sequence, and wherein
a required work step can be selected in the first navigation area and/or in the second navigation area.

16. The tool according to claim 15, wherein the first navigation area is an area with a tree structure.

17. The tool according to claim 15, wherein the first navigation area provides an overview of the project in a tree structure.

18. The tool according to claim 16, wherein the first navigation area provides an overview of the project in a tree structure.

19. The tool according to claim 15, wherein the elements displayed in the first navigation area are displayed in the form of an alphanumeric display.

20. The tool according to claim 16, wherein the elements displayed in the first navigation area are displayed in the form of an alphanumeric display.

21. The tool according to claim 17, wherein the elements displayed in the first navigation area are displayed in the form of an alphanumeric display.

22. The tool according to claim 15, wherein the elements displayed in the second navigation area are each displayed in alphanumeric and graphic form.

23. The tool according to claim 16, wherein the elements displayed in the second navigation area are each displayed in alphanumeric and graphic form.

24. The tool according to claim 17, wherein the elements displayed in the second navigation area are each displayed in alphanumeric and graphic form.

25. The tool according to claim 15, wherein once the required work step has been selected, data associated with said work step is displayed in the data area.

26. The tool according to claim 15, wherein once the required work step has been selected, the alphanumeric display in the first navigation area corresponding to the selected work step and the alphanumeric and graphic display in the second navigation area corresponding to the selected work step are visually marked.

27. The tool according to claim 15, wherein the tool is adapted for configuring, designing, or programming an installation or technical composition.

28. The tool according to claim 22, wherein the data displayed in the data area is displayed in the form of a list containing selectable list elements.

29. The tool according to claim 28, wherein a button is assigned to each selectable list element, which can be clicked on to superimpose a window corresponding to an assistant on the current display, the window containing help information or prompting the inputting of parameters.

30. The tool according to claim 15, wherein status indicators are provided in each of the navigation areas, the status indicators containing information about whether or not a work step has already been completed.

31. The tool according to claim 30, wherein the status indicators further contain information about whether or not the data selection made in a work step has resulted in a non-permitted status.

32. A method for configuring, designing, and/or programming an installation, the method comprising:
providing a graphic user interface displayed on a display, the graphic user interface having at least two navigation areas and a data area, wherein a first navigation area being an area in which the sub-tasks and work steps associated with a project can be displayed in a hierarchically organized manner and wherein a second navigation area being an area in which individual work steps are displayed in their processing sequence;
selecting a work step by navigating in the first or in the second navigation area;
visually marking display elements associated with the selected work step in the first and in the second navigation area; and
displaying data associated with the selected work step in the data area.

33. A digital storage medium comprising a control program adapted for interacting with a computer, an operator unit, and a display for performing the method according to claim 32.
